(19) United States
(12) Patent Application Publication
(10) Pub. No.: US 2021/0153276 A1
(43) Pub. Date: May 20, 2021

(54) RADIO LINK FAILURE MANAGEMENT IN WIRELESS COMMUNICATION NETWORKS

(71) Applicant: TELEFONAKTIEBOLAGET LM ERICSSON (PUBL), Stockholm (SE)

(72) Inventors: Mattias Bergström, SOLLENTUNA (SE); Torsten Dudda, WASSENBERG (DE); Cecilia Eklöf, TÄBY (SE)

(21) Appl. No.: 17/045,117

(22) PCT Filed: Apr. 3, 2019
(86) PCT No.: PCT/IB2019/052737

§ 371 Date: Oct. 2, 2020

Related U.S. Application Data
(60) Provisional application No. 62/653,195, filed on Apr. 5, 2018.

(51) Int. Cl. H04W 76/15; H04L 12/24; H04W 24/02

(52) U.S. Cl. CPC H04W 76/15; H04W 80/02; H04W 24/02; H04L 41/0668

(57) ABSTRACT

In some aspects, methods, apparatuses, and computer program products are provided for handling RLC failures in PDCP duplication where there are two logical channels on which a PDCP entity can send packets. In some aspects, the radio network node may determine a mapping between the primary and secondary logical channels and serving cells, and how this mapping can be configured for the wireless device. In some aspects, the wireless device may take different actions depending on which of a primary and a secondary logical channel, i.e. RLC entity, fails. In some aspects, the wireless device operating in PDCP duplication may notify the radio network node about the failure of a radio link supporting the secondary logical channel without triggering the RLF procedure.

### RELATED APPLICATIONS

The present application claims the benefits of priority of U.S. Provisional Patent Application No. 62/653,195; entitled “RADIO LINK FAILURE MANAGEMENT IN WIRELESS COMMUNICATION NETWORKS”; and filed at the United States Patent and Trademark Office on Apr. 5, 2018; the content of which is incorporated herein by reference.

### TECHNICAL FIELD

The present description generally relates to wireless communications and wireless communication networks, and more particularly relates to management of radio link failure (RLF) in wireless communication networks.

### BACKGROUND

PDCP Duplication

With the feature called PDCP duplication, packets are duplicated for the sake of enhancing reliability. The intention is that since there are two copies sent there is a higher chance of them reaching the destination, compared to if only one is sent. When duplication is used, one PDCP entity is associated with two RLC entities and the PDCP entity creates two copies of each packet and sends one copy via each of the two RLC entities. To achieve the reliability improvement, the traffic from the two different RLC entities are mapped to different serving cells, and the serving cells are in turn associated to different frequencies.

Radio Link Failure

In case the UE radio link towards the network has problems, the radio link may fail. According to current 3GPP specifications, radio link failure (RLF) is triggered when the physical layer detects that the error-rate on the channel is too high, when there have been too many RLC retransmissions, or when there were too many preamble transmission attempts during a random access procedure.

When RLF is detected by the UE, the UE will, if security is enabled, attempt to re-establish the connection to the network, and if security is not enabled, enter IDLE mode.

### SUMMARY

When PDCP duplication is used, a PDCP entity can send packets via two logical channels, a primary logical channel and a secondary logical channel. If problems occur on these logical channels, the associated RLC entities may reach the maximum number of (re)transmissions which could trigger a radio link failure (RLF) procedure. When the RLF procedure is triggered, the UE may attempt to re-establish the connection to the network. However, performing re-establishment may cause unnecessary interruptions in the communication.

In some broad aspects, methods, apparatuses, and computer program products are provided for handling RLC failures (such as reaching the maximum number of RLC retransmissions) for the case of PDCP duplication where there are two logical channels on which a PDCP entity can send packets.

According to one aspect, some embodiments include a method performed by a wireless device served by at least a first set of cells and a second set of cells, connected to at least one radio network node, and operating in a duplication mode (e.g., PDCP duplication). The method comprises transmitting, from a first Radio Link Control (RLC) entity of the wireless device, first RLC protocol data units (PDUs) carrying data received from a Packet Data Convergence Protocol (PDCP) entity of the wireless device, to a first RLC entity associated with the first set of cells over a primary logical channel, and from a second RLC entity of the wireless device, second RLC

PDUs, carrying duplicated data received from the PDCP entity of the wireless device, to a second RLC entity associated with the second set of cells over a secondary logical channel. The method also comprises determining failure of a radio link supporting the secondary logical channel, and responsive to determining failure of the radio link supporting the secondary logical channel, notifying the radio network node about the failure of the radio link supporting the secondary logical channel.

In some embodiments, the method may comprise, or further comprise, when notifying the radio network node about the failure of the radio link supporting the secondary logical channel, transmitting a message to the radio network node, the message comprising information about the failure of the radio link supporting the secondary logical channel. In such embodiments, the message may be Radio Resource Control (RRC) message (e.g., a PDCP-DuplicationFailureInformation message). In some embodiments, the information about the failure of the radio link supporting the secondary logical channel may comprise an identity of the secondary logical channel, an identity of at least one cell of the second set of cells, an identity of a bearer carrying the secondary logical channel, and/or an identity of frequency resources associated with the radio link supporting the secondary logical channel.

In some embodiments, the method may comprise, or further comprise, responsive to determining failure of the radio link supporting the secondary logical channel, suspending the second RLC entity of the wireless device while keeping the first RLC entity active.

In some embodiments, the method may comprise, or further comprise, receiving configuration information from the radio network node, the configuration information indicating that the primary logical channel is to be mapped to the first set of cells and that the secondary logical channel is to be mapped to the second set of cells. In such embodiments, the method may comprise, or further comprise, responsive to receiving configuration information from the radio network node, configuring the primary and secondary logical channels and the mapping of the primary logical channel to the first set of cells and the mapping of the secondary logical to the second set of cells. In some embodiments, receiving configuration information from the radio network node may comprise, or further comprise, receiving a configuration message from the radio network node, the configuration message indicating that the primary logical channel is to be mapped to the first set of cells and that the secondary logical channel is to be mapped to the second set of cells. In some embodiments, the configuration message may be an RRC message (e.g., an RRCConnectionSetup message or an RRCConnectionReconfiguration message).

In some embodiments, the first set of cells and the second set of cells may be both managed by the radio network node. In some other embodiments, the first set of cells may be managed by the radio network node while the second set of cells may be managed by another radio network node.

In some embodiments, the first set of cells may comprise one or more cells, and the second set of cells may comprise one or more cells.

According to another aspect, some embodiments include a wireless device adapted, configured, enabled, or otherwise operable, to perform one or more of the described wireless device functionalities (e.g. actions, operations, steps, etc.).

In some embodiments, the wireless device may comprise one or more transceivers and processing circuitry operatively connected to the one or more transceivers. The one or more transceivers are configured to enable the wireless device to communicate with one or more radio network nodes over a wireless interface. The processing circuitry is configured to enable the wireless device to perform one or more of the described wireless device functionalities. In some embodiments, the processing circuitry may comprise at least one processor and at least one memory, the memory storing instructions which, upon being executed by the processor, enable the wireless device to perform one or more of the described wireless device functionalities.

In some embodiments, the wireless device may comprise one or more functional units (also referred to as modules) configured to perform one or more of the described wireless device functionalities. In some embodiments, these functional units may be embodied by the one or more transceivers and the processing circuitry of the wireless device.

According to another aspect, some embodiments include a computer program product. The computer program product comprises computer-readable instructions stored in a non-transitory computer-readable storage medium of the computer program product. When the instructions are executed by processing circuitry (e.g., at least one processor) of the wireless device, they enable the wireless device to perform one or more of the described wireless device functionalities.

According to another aspect, some embodiments include a method performed by a radio network node connected to a wireless device, the wireless device being served by at least a first set of cells and a second set of cells, the radio network node operating in a duplication mode (e.g., PDCP duplication). The method comprises receiving, at a PDCP entity of the radio network node, first RLC PDUs carrying data received at a first RLC entity associated with the first set of cells from a first RLC entity of the wireless device over a first logical channel, and second RLC PDUs carrying duplicated data received at a second RLC entity associated with the second set of cells from a second RLC entity of the wireless device over a second logical channel, and receiving a notification from the wireless device about a failure of a radio link supporting the secondary logical channel.

In some embodiments, the method may comprise, or further comprise, responsive to receiving the notification from the wireless device about the failure of the radio link supporting the secondary logical channel, suspending the second RLC entity associated with the second set of cells while keeping the first RLC entity associated with the first set of cells active.

In some embodiments, the method may comprise, or further comprise, when receiving the notification from the wireless device about the failure of the radio link supporting the secondary logical channel, receiving a message from the wireless device, the message comprising information about the failure of the radio link supporting the secondary logical channel. In some embodiments, the message may be an RRC message (e.g., a PDCP-DuplicationFailureInformation message). In some embodiments, the information about the failure of the radio link supporting the secondary logical channel may comprise an identity of the secondary logical channel, an identity of at least one cell of the second set of cells, an identity of a bearer carrying the secondary logical channel, and/or an identity of frequency resources associated with the radio link supporting the secondary logical channel.

In some embodiments, the method may comprise, or further comprise, transmitting configuration information to the wireless device, the configuration information indicating that the primary logical channel is to be mapped to the first set of cells and that the secondary logical channel is to be mapped to the second set of cells. In such embodiments, the method may comprise, or further comprise, when transmitting configuration information to the wireless device, transmitting a configuration message to the wireless device, the configuration message indicating that the primary logical channel is to be mapped to the first set of cells and that the secondary logical channel is to be mapped to the second set of cells. In some embodiments, the configuration message may be an RRC message (e.g., an RRCConnectionSetup message or an RRCConnectionReconfiguration message).

In some embodiments, the first set of cells and the second set of cells may be both managed by the radio network node. In some other embodiments, the first set of cells may be managed by the radio network node while the second set of cells may be managed by another radio network node.

In some embodiments, the first set of cells may comprise one or more cells, and the second set of cells may comprise one or more cells.

According to another aspect, some embodiments include a radio network node adapted, configured, enabled, or otherwise operable, to perform one or more of the described radio network node functionalities (e.g. actions, operations, steps, etc.).

In some embodiments, the radio network node may comprise one or more transceivers, one or more communication interfaces, and processing circuitry operatively connected to the one or more transceivers and to the one or more communication interfaces. The one or more transceivers are configured to enable the radio network node to communicate with one or more wireless devices over a wireless interface. The one or more communication interfaces are configured to enable the radio network node to communicate with one or more other radio network nodes (e.g., via a radio access network communication interface), with one or more core network nodes (e.g., via a core network communication interface), and/or with one or more other network nodes. The processing circuitry is configured to enable the radio network node to perform one or more of the described radio network node functionalities. In some embodiments, the processing circuitry may comprise at least one processor and at least one memory, the memory storing instructions which, upon being executed by the processor, configure the at least one processor to enable the radio network node to perform one or more of the described radio network node functionalities.

In some embodiments, the radio network node may comprise one or more functional units (also referred to as modules) configured to perform one or more of the described radio network node functionalities. In some embodiments, these functional units may be embodied by the one or more transceivers and the processing circuitry of the radio network node.

According to another aspect, some embodiments include a computer program product. The computer program product comprises computer-readable instructions stored in a non-transitory computer-readable storage medium of the computer program product. When the instructions are executed by processing circuitry (e.g., at least one processor) of the radio network node, they enable the radio network node to perform one or more of the described radio network node functionalities.

Some embodiments may enable the radio network node to determine a mapping between the primary and secondary logical channels and the serving cells, and how this mapping can be configured for the wireless device. Some embodiments may enable the wireless device to take different actions depending on which of a primary and a secondary logical channel, i.e. RLC entity, fails. Some embodiments may enable the wireless device to indicate to the radio network node which of the serving cells failed by referring, for instance, to the primary or secondary logical channel. Some embodiments may enable a wireless device operating in PDCP duplication to notify the radio network node about the failure of a radio link supporting the secondary logical channel without triggering the RLF procedure.

This summary is not an extensive overview of all contemplated embodiments and is not intended to identify key or critical aspects or features of any embodiments or to delineate any embodiments. Other aspects and features will become apparent to those ordinarily skilled in the art upon review of the following description of specific embodiments with the figures.

### BRIEF DESCRIPTION OF THE DRAWINGS

Exemplary embodiments will be described in more detail with reference to the following figures, in which:

FIG. 1 is a schematic diagram of an example wireless communication network in accordance with some embodiments.

FIGS. 2A and 2B are schematic diagrams of an example carrier aggregation (CA) deployment (FIG. 2A) and of an example dual connectivity (DC) deployment (FIG. 2B) in accordance with some embodiments.

FIGS. 3A and 3B are block diagrams of examples of a portion of the protocol stack in a carrier aggregation (CA) deployment (FIG. 3A) and in a dual connectivity (DC) deployment (FIG. 3B) in accordance with some embodiments.

FIG. 4 is a signaling diagram in accordance with some embodiments.

FIG. 5 is a flow chart of operations of a wireless device in accordance with some embodiments.

FIG. 6 is a flow chart of operations of a radio network node in accordance with some embodiments.

FIG. 7 is a block diagram of a wireless device in accordance with some embodiments.

FIG. 8 is another block diagram of a wireless device in accordance with some embodiments.

FIG. 9 is a block diagram of a radio network node in accordance with some embodiments.

FIG. 10 is another block diagram of a radio network node in accordance with some embodiments.

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

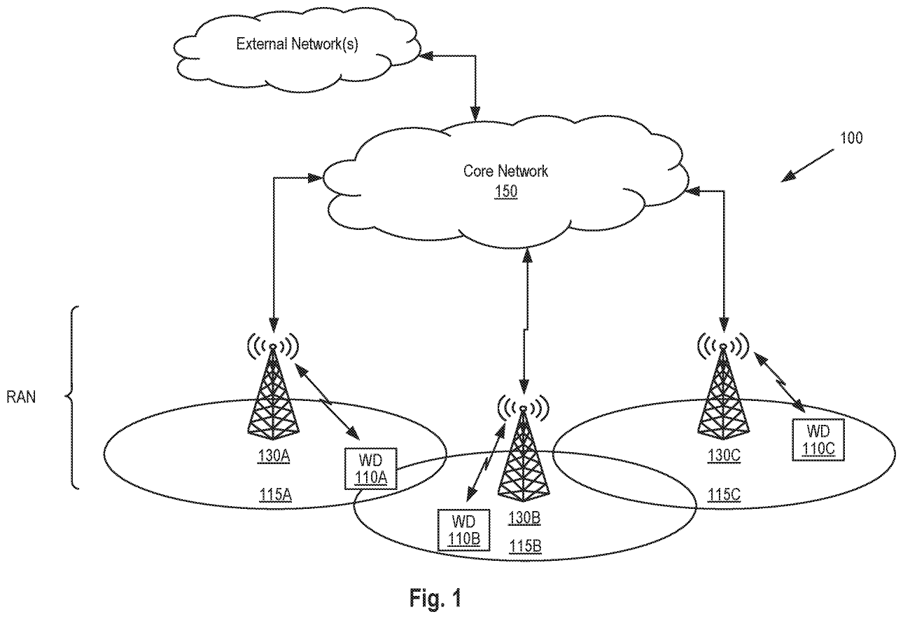

FIG. 1 illustrates an example of a wireless communication network 100 that may be used for wireless communications. Wireless network 100 includes wireless devices 110A-110C (collectively referred to as wireless devices or WDs 110) and a plurality of radio network nodes 130A-130C (e.g., eNBs in LTE, gNBs in NR, etc.) (collectively referred to as radio network node or radio network nodes 130) directly or indirectly connected to a core network 150 which may comprise a plurality of core network nodes (e.g., MMEs, SGWs, and/or PGWs in LTE/EPC, AMFs, SMFs, and/or UPFs in NGC, etc.) (collectively referred to as core network node or core network nodes). The wireless network 100 may use any suitable radio access network (RAN) deployment scenarios, including UMTS Terrestrial Radio Access Network, UTRAN, Evolved UMTS Terrestrial Radio Access Network, EUTRAN, and Next Generation Radio Access Network, NG-RAN.

Wireless devices 110 within coverage areas 115 may each be capable of communicating directly with radio network nodes 130 over a wireless interface. In certain embodiments, wireless devices may also be capable of communicating with each other via device-to-device (D2D) communication. As an example, wireless device 110A may communicate with radio network node 130A over a wireless interface. That is, wireless device 110A may transmit wireless signals to and/or receive wireless signals from radio network node 130A. The wireless signals may contain voice traffic, data traffic, control signals, and/or any other suitable information. In some embodiments, an area of wireless signal coverage 115 associated with a radio network node 130 may be referred to as a cell 115.

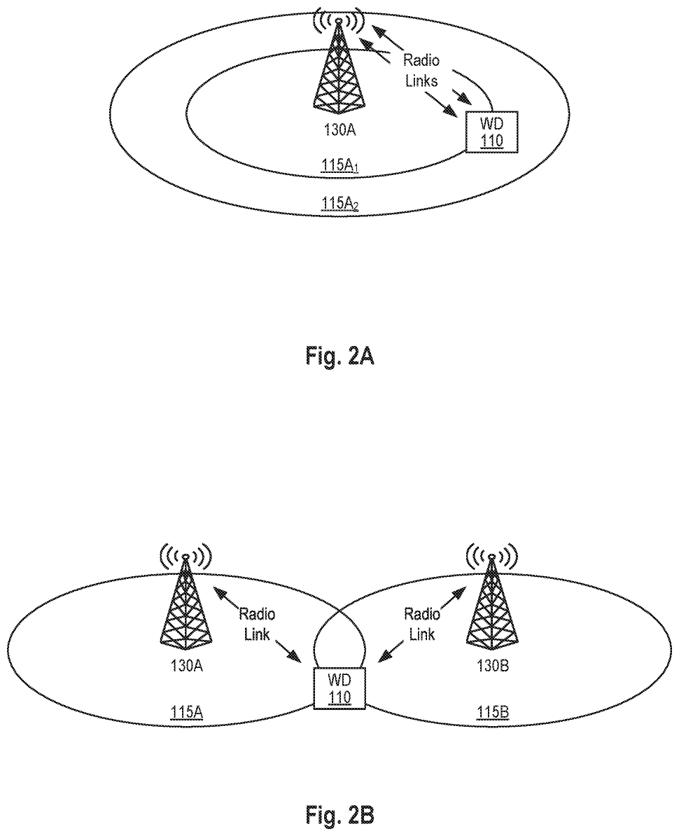

Turning now to FIGS. 2A and 2B, examples of a carrier aggregation (CA) deployment and of a dual connectivity (DC) deployment are respectively illustrated. Referring first to FIG. 2A, in CA, a single radio network node can establish multiple radio links with a wireless device, each of the radio links being served by a different cell usually operating on different frequencies or different carriers. In the example shown in FIG. 2A, the wireless device is served by two cells, e.g., cell 115A₁ and 115A₂, which are managed by the same radio network node (e.g., 130A). In CA, one of the cells is the primary cell (PCell) while the other cell(s) is/are secondary cell(s) (SCell(s)). Though only two cells are shown, a CA deployment can involve more than two cells.

Referring now to FIG. 2B, in DC, a (first) radio network node can also establish multiple radio links with a wireless device, each of the radio links being served by a different cell. However, in DC, and in contrast with CA, at least one of the radio links is established via a second radio network node which is in communication with the first radio network node (e.g., via the X2 interface in LTE). In the example shown in FIG. 2B, the wireless device is served by two cells, cell 115A managed by (first) radio network node 115A and cell 115B managed by (second) radio network node 115B. In DC, one of the cells is the primary cell (PCell) while the other of the cells is the primary secondary cell (PSCell). In deployment according to the LTE standards, the radio network node managing the primary cell is referred to as the Master eNB or MeNB while the radio network node managing the primary secondary cell is referred to as the Secondary eNB or SeNB.

Though not shown for simplicity, CA and DC can be combined wherein the first radio network node, the second radio network, or both, can each manage multiple cells serving the wireless device.

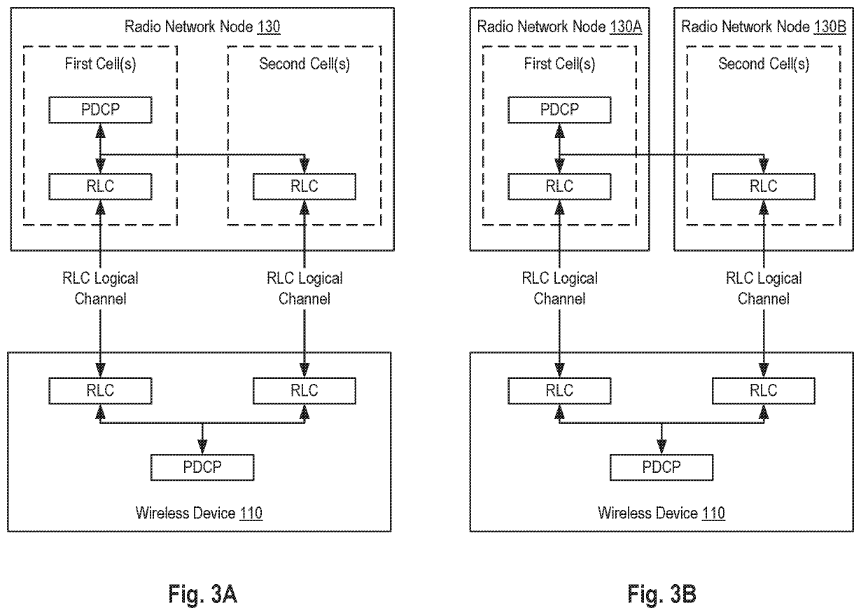

Referring now to FIGS. 3A and 3B, high-level views of portion of the protocol stacks of both CA and DC deployments are respectively shown. As illustrated in FIG. 3A, in a CA deployment, a single PDCP entity associated with a first cell (or first set of cells) is associated and interacts with at least two RLC entities, one associated with the first cell (or first set of cells) and the other associated with the second cell (or second set of cells). In turn, each of these two RLC entities are associated and interact with corresponding RLC entities in the wireless device over respective logical channels. Since the logical channels are established and mapped to different cells, the logical channels are typically supported by different radio links. Finally, the RLC entities of the wireless device are associated and interact with a single PCDP entity. Notably, in a CA deployment, both the first cell (or the first set of cells) and the secondary cell (or the second set of cells) are managed by the same radio network node. In other words, in a CA deployment, a wireless device can be served by two cells (or two sets of cells) managed by the same radio network node.

Turning now to FIG. 3B, in a DC deployment, a single PDCP entity associated with the first cell (or first set of cells) is associated and interacts with two RLC entities, one associated with the first cell (or first set of cells) and the other associated with the second cell (or second set of cells). In turn, each of these two RLC entities are associated and interact with corresponding RLC entities in the wireless device over respective logical channels. As in the CA deployment, in a DC deployment, since the logical channels are established and mapped to different cells, the logical channels are typically supported by different radio links. Finally, the RLC entities of the wireless device are associated and interact with a single PCDP entity. Notably, in a DC deployment, the first cell (or first set of cells) is managed by a first or master radio network node while the second cell (or second set of cells) is managed by a second or secondary radio network node.

To improve reliability in certain scenarios, it has been proposed for the RLC entities to exchange RLC PDUs carrying duplicate PDCP PDUs. In other words, it has been proposed to allow a wireless device operating in carrier aggregation or in dual connectivity to further operate in a duplication mode (also referred to as PDCP duplication). In the duplication mode, the PDCP entity of the radio network node managing the first cell(s) (i.e., the radio network node in CA or the master radio network node in DC) duplicates the PDCP PDUs to be sent to the wireless device and send them to the RLC entities of the first cell(s) and second cell(s) serving the wireless device to be ultimately sent to the wireless device over their respective logical channels. Similarly, the PDCP entity of the wireless device duplicates the PDCP PDUs to be sent to the radio network node managing the first cell(s) and send them to each of the RLC entities associated with the RLC entities of the first and second cells serving the wireless device to be ultimately sent to the radio network node managing the first cell(s) over their respective logical channels.

In PDCP duplication, it has been proposed that an RLC logical channel be considered the primary or secondary logical channel depending on which field(s) (e.g. fields in an RRC configuration message) one or more components/elements associated with this logical channel have been configured with. In that regard, it has been proposed that if an RLC entity for a logical channel has been configured in a first set of RRC fields, then this logical channel is considered to be the primary logical channel, while if the RLC entity has been configured in a second set of RRC fields, its associated logical channel is considered to be the secondary logical channel.

An example of how the primary and secondary logical channels are determined is shown below. The ASN code below shows some of the parameters of the RadioResourceConfigDedicated information element that could be used based on 3GPP TS 36.331 V15.0.1. This information element can be part of an RRC configuration message such as an RRCConnectionSetup message or an RRCConnectionReconfiguration message. In this information element, the radio network node configures radio links, RLC entities, logical channel identities, and logical channel configurations. The primary logical channel is considered to be the logical channel which is associated with the fields rlc-Config, logicalChannelIdentity, and logicalChannelConfig, while the secondary logical channel is considered to be the logical channel which is associated with the fields rlc-Config-Dupl-r15, logicalChannelId-Dupl-v15xy, and logicalChannelConfig-Dupl-v15xy (the x and the y indicate that the version number for these fields is not yet confirmed).

```
DRB-ToAddMod ::= SEQUENCE {
  eps-BearerIdentity INTEGER (0..15) OPTIONAL, -- Cond DRB-Setup
  drb-Identity DRB-Identity,
  pdcp-Config PDCP-Config OPTIONAL, -- Cond PDCP
  rlc-Config RLC-Config OPTIONAL, -- Cond SetupM
  logicalChannelIdentity INTEGER (3..10) OPTIONAL, -- Cond DRB-
SetupM
  logicalChannelConfig LogicalChannelConfig OPTIONAL, -- Cond SetupM
  . . .,
  [[ drb-TypeChange-r12 ENUMERATED (toMCG) OPTIONAL, -- Need OP
      rlc-Config-v1250 RLC-Config-v1250 OPTIONAL -- Need ON
  ]],
  [[ rlc-Config-v1310 RLC-Config-v1310 OPTIONAL, -- Need ON
      drb-TypeLWA-r13 BOOLEAN OPTIONAL, -- Need ON
      drb-TypeLWIP-r13 ENUMERATED {lwip, lwip-DL-only,
                                        lwip-UL-only, eutran} OPTIONAL -- Need
ON
  ]],
  [[ rlc-Config-v1430 RLC-Config-v1430 OPTIONAL, -- Need ON
      lwip-UL-Aggregation-r14 BOOLEAN OPTIONAL, -- Cond LWIP
      lwip-DL-Aggregation-r14 BOOLEAN OPTIONAL, -- Cond LWIP
      lwa-WLAN-AC-r14 ENUMERATED {ac-bk, ac-be, ac-vi, ac-vo} OPTIONAL -- Cond UL-
LWA
  ]],
  [[ rlc-Config-v15xy RLC-Config-v15xy OPTIONAL, -- Need ON
      rlc-Config-Dupl-r15 RLC-Config-v15xy OPTIONAL, -- Need On
      logicalChannelId-Dupl-v15xy INTEGER (3..10) OPTIONAL, -- Need ON
      logicalChannelConfig-Dupl-v15xy LogicalChannelConfig OPTIONAL -- Need ON
  ]]
}
```

Notably, though the expressions “primary logical channel” and “secondary logical channel” are used in the description, other expressions could be used to describe or refer to them. For instance, for the primary logical channel, the expressions primary RLC logical channel, main link, main leg, main logical channel, primary link, primary leg, PDCP duplication main leg, PDCP duplication main transmission path, transmission path associated with a primary cell or cell group, etc. may be used to denote the primary logical channel. Similarly, the expressions secondary RLC logical channel, secondary link, secondary leg, duplication link, duplication leg, duplication logical channel, PDCP duplication secondary leg, PDCP duplication secondary leg link, PDCP duplication secondary transmission path, transmission path associated with a secondary cell or cell group, etc. may be used to denote the secondary logical channel.

Methods in the Primary and Secondary Duplication Links with Cells

As indicated above, the radio network node can indicate to the wireless device which logical channels can be sent on which serving cells. This can be done by providing a mapping to the wireless device between logical channels and serving cells, e.g. restricting logical channels from being sent on those cells on which traffic of the logical channel should not be sent on.

In some embodiments, the radio network node can configure (e.g. by providing the aforementioned mapping/restrictions) the wireless device such that the primary logical channel is sent on a set of serving cell(s) containing one or more serving cells which are considered more important than other cells. Examples of such more important cells include a Primary Cell (PCell), a Primary Secondary Cell (PSCell), a PUCCH SCell, etc., compared to, for example, Secondary Cell (SCells).

As it will be described below, the wireless device may trigger a RLF if the wireless device has problems on the primary logical channel (i.e., with a radio link supporting the primary logical channel), while only sending a notification or indication of a problem if the wireless device has problems on the secondary logical channel (i.e., with a radio link supporting the secondary logical channel). This means that by providing mapping/restriction in the manner described according to these embodiments, the behavior would be:

if there are problems on the primary logical channel, it may mean that the wireless device has problems on an important cell and hence the wireless device would trigger RLF;

if there are problems on the secondary logical channel, it may mean that the wireless device has problems on less important cells and hence the wireless device would send the indication.

So, if the radio network node provides a mapping between logical channels and serving cells as above, the radio network node can make sure that if there are problems on an important cell (e.g. the PCell) the wireless device triggers RLF, but if there are problems on a less important cell (e.g. an SCell) the wireless device would not trigger RLF, but instead send a notification or an indication.

Differentiated Action Depending on Which Duplication Link Has Problems

In some embodiments, and as indicated above, the wireless device may trigger a first action or series of actions if there are problems on the primary logical channel for a duplicated bearer, while the wireless device may trigger a second action or series of actions if there are problems on a secondary logical channel of a duplicated bearer. In some embodiments, the first action may be to trigger a Radio Link Failure (RLF) procedure which may result in the wireless device attempting to re-establish the connection to the network. The second action may be to notify the network or to provide a report to the network indicating that the problem has occurred. Notably, as it will be shown later, the procedure for providing a report to the network may be referred to as a type of radio link failure (referred herein as “radio link failure [. . . ] for the PDCP duplication secondary logical channel”), however this type of radio link failure will not trigger re-establishment which the normal radio link failure procedure would result in.

In some embodiments, when there are problems on a secondary logical channel, the wireless device may further suspend the RLC entity/entities associated with the PDCP duplication secondary logical channel.

The radio network node may, in response to such a report described as the second action, deconfigure the duplication feature for this bearer, reestablish the affected RLC entity of the failing link, or deconfigure serving cells, etc.

Advantageously, some embodiments may avoid triggering re-establishment of the connection to the network when only the secondary logical channel has problems. In other words, in such embodiments, the wireless device may only trigger RLF which causes re-establishment if the primary logical channel has problems, but not if the secondary logical channel has problems. This may ensure that the wireless device only will trigger RLF which causes re-establishment if important cells face issues.

In 3GPP TS 36.331 v15.0.1 section 5.6.13, it is described a secondary cell group (SCG) failure mechanism. This procedure causes the wireless device to suspend all transmissions in the SCG, and to reset the MAC entity associated with the SCG. However, it may not be wanted that these actions are performed in case there is a problem on a PDCP duplication secondary logical channel. For example, if the wireless device has cell X, cell Y and cell Z in an SCG and the PDCP duplication secondary logical channel is mapped only to cell X, then failure caused by poor performance on cell X would not motivate stopping the use of cell Y and cell Z.

It has been described how a wireless device configured with CA can send a first type of report (e.g., a SCellFailureReport message) if the maximum number of RLC retransmissions is reached on one of the carriers mapped to the duplicated bearer while the wireless device triggers the SCG failure mechanism if configured with DC. In contrast with a such an approach, some embodiments advantageously ensure that the behavior is unified when the wireless device faces problems with a PDCP duplication secondary link, i.e., the wireless device notifies the radio network node (e.g., via a PDCP Duplication Failure Information message) regardless of if Carrier Aggregation or Dual Connectivity is configured, which may simplify PDCP duplication secondary link is within an SCG or within an MCG. Furthermore, as mentioned above, the wireless device triggers for a secondary RLC entity involved in duplication a duplication failure indication specific to this failing RLC entity. This failure indication is specific to the RLC entity, i.e. may lead to suspension of this RLC entity and indicates failure of the RLC entity to the network. They network can hence deconfigure the failed RLC entity. Failure indications specific to the RLC entity, i.e. logical channel, is beneficial compared to indicating failure specific to an SCell (which may include suspending uplink transmissions on this SCell), since an SCell may be used by multiple other logical channels as well, that may not suffer the same outage/failure situation than the RLC entity in question. This might be the case for specific logical channel prioritization configurations in which some logical channels are preferred above others, leading rather to failures in the not-prioritized RLC entities. This means that only some RLC entities do not work (the failing ones) and only those should be deconfigured, while others may be kept, and in particular SCell uplink transmission operation may be kept. In order to trigger these deconfiguration in an efficient way, the network should be informed by the wireless device for the RLC failure of the duplication secondary logical channel, and not for as SCell failure.

Moreover, triggering the duplication failure indication as described here based on detecting RLC failure in the secondary RLC entity involved in the duplication bearer has the advantage of being unique to the specific bearer. If the failure indication were defined to be triggered for RLC logical channels for which transmissions are restricted to a certain SCell, the indication would also be triggered for a primary RLC logical channel of duplication restricted to transmissions in that SCell. Triggering duplication failure indications depending on whether the RLC entity is defined as primary or secondary RLC entity in duplication has thus the advantage of radio network node being able to define transmission restrictions of both RLC entities flexibly, independently of the failure triggering, i.e. can associate RLC entities freely to PCell or any SCell.

Indicating a Source of The Failure

In case of failure in an RLC entity, which may be considered to have occurred if a maximum number of RLC (re)transmissions has been reached, the wireless device may provide an indication of which RLC entity (or group of RLC entities) the error occurred for. One way of indicating which RLC entity the error occurred for is by indicating in the failure report an identity of the bearer, logical channel or cell/frequency/carrier (i.e., radio resources) for which the error occurred. The radio network node can then determine which cell or group of cells have problems.

This has the benefit that the radio network node could, with this knowledge, decide to apply an action only for the problematic cell(s) (e.g. deconfigure them, deactivate them, etc.) but leave the non-problematic cells as they are. This may ensure that only problematic cells are removed while non-problematic cells are kept and could be used for communication from/to the wireless device. Also, it is an effective way to provide the information needed by the radio network node since only a single bearer identity needs to be signaled, which only costs a few bits of signaling.

In some embodiments, the following sections of 3GPP TS 36.331 V15.0.1 may be modified as follows to enable one or more of the described embodiments.

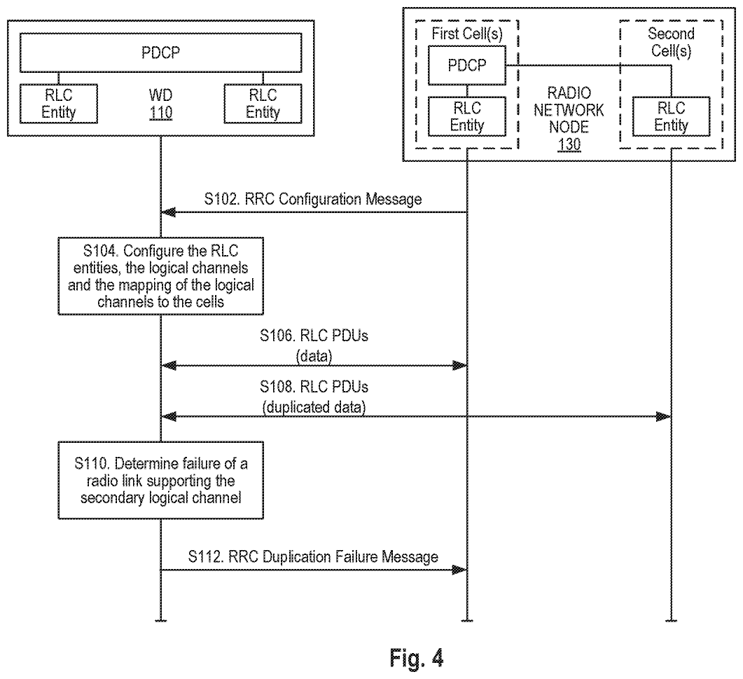

Referring to FIG. 4, a high-level signaling and operating diagram according to some embodiments is illustrated. The diagram illustrates the PCDP entity and a first RLC entity associated with a first cell (or a first set of cells) and a second RLC entity associated with a second cell (or a second set of cells). In FIG. 4, the two cells are managed by a single radio network node 130 as it would be the case in a CA deployment (see also FIGS. 2A and 3A). Notably, in a DC deployment, the first cell(s) would be managed by a first radio network node and the second cell(s) would be managed by a second radio network node (see also FIGS. 2B and 3B).

As illustrated, the radio network node may send an RRC configuration message to the wireless device (action S102) to configure the wireless device with the appropriate parameters to enable both carrier aggregation (or dual connectivity) and PDCP duplication. The radio network node may send this RRC message during connection setup via an RRCConnectionSetup message or later when reconfiguring the connection via an RRCConnectionReconfiguration message. Regardless of which message is used, once the wireless device receives this message, it configures the two RLC entities and their associated logical channels, maps the logical channels to first cell(s) and second cell(s) as indicated, and assigns or otherwise determines one of the logical channels as the primary logical channel and the other of the logical channels as the secondary logical channel for PDCP duplication (action S104). In some embodiments, the wireless device determines the primary logical channel as the one described and configured by the fields rlc-Config, logicalChannelIdentity and logicalChannelConfig, and determines the secondary logical channel as the one described and configured by the fields rlc-Config-Dupl-r15, logicalChannelId-Dupl-v15xy, and logicalChannelConfig-Dupl-v15xy.

Once the RLC entities and their corresponding logical channels are configured, the wireless device can exchange data (i.e., RLC PDUs) with the first cell(s) and the second cell(s). In FIG. 4, the primary logical channel is between the wireless device and the first cell(s) while the secondary logical channel is between the wireless device and the second cell(s). As such, the wireless device exchanges data (i.e., RLC PDUs) with the first cell(s) over the primary logical channel (action 5106) while the wireless device exchanges duplicated data (i.e., RLC PDUs carrying duplicated data) with the second cell(s) over the secondary logical channel (action S108). The radio network node typically decides which logical channel will be associated with which cell(s).

At some point in time, the wireless device determines failure of a radio link that supports the secondary logical channel (action S110). The failure of the radio link that supports the secondary logical channel may be determined upon the wireless device detecting that a maximum number of (re)transmission attempts has been reached in the RLC entity associated with the secondary logical channel. Upon making this determination, the wireless device notifies the radio network node about the failure of the radio link that supports the secondary logical channel. In some embodiments, and as illustrated in FIG. 4, the wireless device may notify the radio network node about the failure of the radio link that supports the secondary logical channel by sending an RRC message including information about the radio link that supports the secondary logical channel and/or about the secondary logical channel. In some embodiments, the RRC message may be a newly defined RRC message, e.g., an RRC PDCP-DuplicationFailureInformation message, while in other embodiments, the RRC message may be an existing RRC message modified to further carry information about the radio link that supports the secondary logical channel and/or about the secondary logical channel.

In addition to notifying the radio network node about the failure of the radio link supporting the secondary logical channel, the wireless device may take further actions. For instance, in some embodiments, the wireless device may suspend the second RLC entity (i.e., the RLC entity associated with the secondary logical channel) while keeping the first RLC entity (i.e., the RLC entity associated with the primary logical channel) active.

Similarly, upon being notified of the failure of the radio link supporting the secondary logical channel, the radio network node may take further actions. For instance, in some embodiments, the radio network node may suspend the second RLC entity (i.e., the RLC entity associated with the secondary logical channel) while keeping the first RLC entity (i.e., the RLC entity associated with the primary logical channel) active. Additionally, or alternatively, the radio network node may deconfigure or deactivate PDCP duplication. Additionally, or alternatively, the radio network node may deconfigure the cell associated with the failed radio link.

Though not shown in FIG. 4, if the wireless device determines failure of a radio link that supports the primary logical channel, the wireless device may trigger the radio link failure procedure which may comprise attempting to re-establish the failed radio link, that is attempting to re-establish the connection to the network.

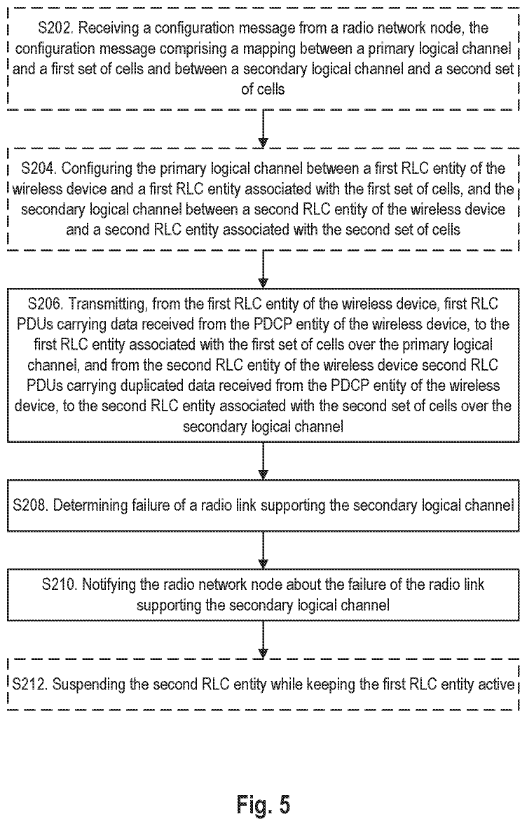

FIG. 5 is a flow chart that illustrates some operations of a wireless device in accordance with some embodiments. As illustrated, the wireless device may first receive configuration information from a radio network node, the configuration information indicating that a primary logical channel is to be mapped to a first set of cells and that a secondary logical channel is to be mapped to a second set of cells for use in PDCP duplication (action S202). The configuration information may be received in a configuration message from the radio network node, the configuration message comprising or otherwise indicating the mapping between the primary logical channel and the first set of cells and between the secondary logical channel and the second set of cells. In some embodiments, the configuration message may be an RRC message such as an RRCConnectionSetup message (used during connection setup) or an RRCConnectionReconfiguration message (used when reconfiguring the connection).

Upon receiving the configuration message, the wireless device may configure the primary logical channel between a first RLC entity of the wireless device and a first RLC entity associated with the first set of cells, and the secondary logical channel between a second RLC entity of the wireless device and a second RLC entity associated with the second set of cells (action S204).

Once the RLC entities and their respective logical channels have been properly configured, the wireless device may transmit from the first RLC entity of the wireless device, first RLC PDUs carrying data received from the PDCP entity of the wireless device, to the first RLC entity associated with the first set of cells over the primary logical channel, and from the second RLC entity of the wireless device, second RLC PDUs carrying duplicated data received from the PDCP entity of the wireless device, to the second RLC entity associated with the second set of cells over the secondary logical channel (action S206).

At some point in time, the wireless device may determine, or otherwise detect, failure of a radio link supporting the secondary logical channel (action S208).

Responsive to determining failure of the radio link supporting the secondary logical channel, the wireless device may notify the radio network node about the failure of the radio link supporting the secondary logical channel (action S210). In some embodiments, notifying the radio network node may comprise transmitting a message to the radio network node, the message comprising information about the failure of the radio link supporting the secondary logical channel. In some embodiments, the message may be an RRC message such as a newly defined PDCP-DuplicationFailureInformation message or an existing RRC message carrying information about the radio link that supports the secondary logical channel and/or about the secondary logical channel.

Also responsive to determining failure of the radio link supporting the secondary logical channel, the wireless device may additionally suspend the second RLC entity while keeping the first RLC entity active (action S212).

It is understood that in some embodiments, the blocks of the flowchart may occur out of the order noted in the figure. For example, two blocks shown in succession may, in fact, be executed substantially concurrently, or the blocks may sometimes be executed in the reverse order, depending upon the functionality involved. Also, the blocks in dashed lines may be considered optional, at least in some embodiments.

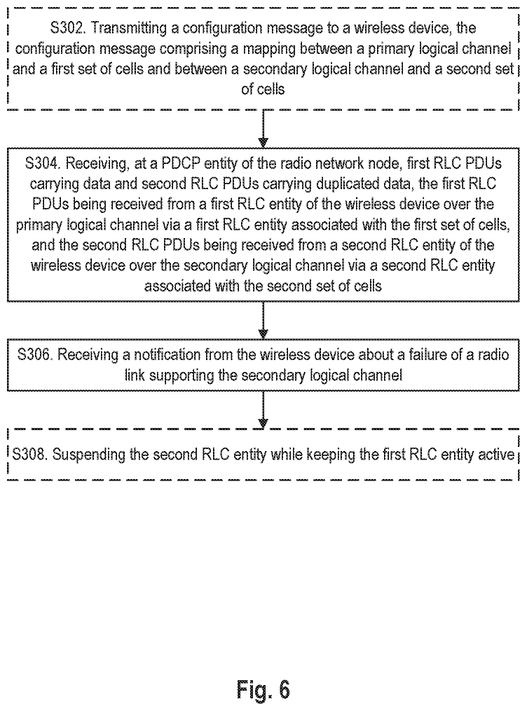

FIG. 6 is a flow chart that illustrates some operations of a radio network node in accordance with some embodiments. As illustrated, the radio network node may first transmit configuration information to a wireless device, the configuration information indicating that a primary logical channel is to be mapped to a first set of cells and that a secondary logical channel is to be mapped to a second set of cells for use in PDCP duplication (action S302). The configuration information may be transmitted in a configuration message to the wireless device, the configuration message comprising or otherwise indicating the mapping between the primary logical channel and the first set of cells and between the secondary logical channel and the second set of cells. In some embodiments, the configuration message may be an RRC message such as an RRCConnectionSetup message (used during connection setup) or an RRCConnectionReconfiguration message (used when reconfiguring the connection).

Once the RLC entities and their respective logical channels have been properly configured at the wireless device, the radio network node receives, at a PDCP entity of the radio network node, first RLC PDUs carrying data and second RLC PDUs carrying duplicated data, the first RLC PDUs being received from a first RLC entity of the wireless device over the primary logical channel via a first RLC entity associated with the first set of cells, and the second RLC PDUs being received from a second RLC entity of the wireless device over the secondary logical channel via a second RLC entity associated with a second set of cells (action S304).

At some point in time, the radio network node may receive a notification from the wireless device about the failure of a radio link supporting the secondary logical channel (action S306). In some embodiments, receiving the notification may comprise receiving a message from the wireless device, the message comprising information about the failure of the radio link supporting the secondary logical channel. In some embodiments, the message may be an RRC message such as a newly defined PDCP-DuplicationFailureInformation message or an existing RRC message carrying information about the radio link that supports the secondary logical channel and/or about the secondary logical channel.

Responsive to receiving the notification from the wireless device, the radio network node may suspend the RLC entity associated with the second set of cells while keeping the RLC entity associated with the first set of cells active (action S308). The radio network node may additionally or alternatively perform other actions such as deconfiguring the cell associated with the failed radio link.

It is understood that in some embodiments, the blocks of the flowchart may occur out of the order noted in the figure. For example, two blocks shown in succession may, in fact, be executed substantially concurrently, or the blocks may sometimes be executed in the reverse order, depending upon the functionality involved. Also, the blocks in dashed lines may be considered optional, at least in some embodiments.

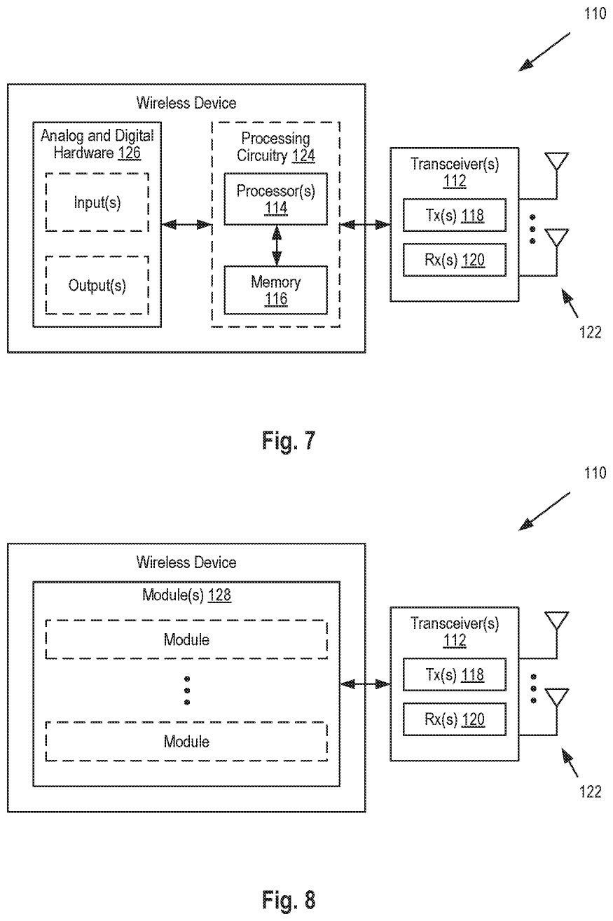

Some embodiments of a wireless device (WD) 110 will now be described with respect to FIGS. 7 and 8. Even though the expression wireless device is used throughout the description, it is to be understood that the expression is used generically. In that sense, a wireless device generally refers to a device capable, configured, arranged, and/or operable to communicate wirelessly with one or more network nodes (e.g., radio network nodes) and/or with one or more other wireless devices. In some embodiments, a wireless device may be configured to transmit and/or receive information without direct human interaction. Such a wireless device may be referred to as a Machine Type Communication (MTC) device or as a Machine-to-Machine (M2M) device.

Notably, different communication standards may use different terminology when referring to or describing wireless device. For instance, 3GPP uses the terms User Equipment (UE), Mobile Equipment (ME) and Mobile Terminal (MT). For its part, 3GPP2 uses the terms Access Terminal (AT) and Mobile Station (MS). And IEEE 802.11 (also known as WiFi™) uses the term station (STA). Understandably, the generic expression wireless device encompasses these terms.

FIG. 7 is a block diagram of an exemplary wireless device 110 according to some embodiments. Wireless device 110 includes one or more of a transceiver 112, processor 114, and memory 116. In some embodiments, the transceiver 112 facilitates transmitting wireless signals to and receiving wireless signals from radio network node 130 (e.g., via transmitter(s) (Tx) 118, receiver(s) (Rx) 120, and antenna(s) 122). The processor 114 executes instructions to provide some or all of the functionalities described above as being provided by wireless device 110, and the memory 116 stores the instructions to be executed by the processor 114. In some embodiments, the processor 114 and the memory 116 form processing circuitry 124.

The processor 114 may include any suitable combination of hardware to execute instructions and manipulate data to perform some or all of the described functions of wireless device 110, such as the functions of wireless device 110 described above. In some embodiments, the processor 114 may include, for example, one or more computers, one or more central processing units (CPUs), one or more microprocessors, one or more application specific integrated circuits (ASICs), one or more field programmable gate arrays (FPGAs) and/or other logic.

The memory 116 is generally operable to store instructions, such as a computer program, software, an application including one or more of logic, rules, algorithms, code, tables, etc. and/or other instructions capable of being executed by a processor. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor of wireless device 110.

Other embodiments of wireless device 110 may include additional components beyond those shown in FIG. 7 that may be responsible for providing certain aspects of the wireless device's functionalities, including any of the functionalities described above and/or any additional functionalities (including any functionality necessary to support the solution described above). As just one example, wireless device 110 may include input devices and circuits, output devices, and one or more synchronization units or circuits, which may be part of the processor. Input devices include mechanisms for entry of data into wireless device 110. As an example, wireless device 110 may include additional hardware 126 such as input devices and output devices. Input devices include input mechanisms such as microphone, input elements, display, etc. Output devices include mechanisms for outputting data in audio, video and/or hard copy format. For example, output devices may include a speaker, a display, etc.

FIG. 8 is a block diagram of another exemplary wireless device 110 in accordance with some embodiments. As illustrated, in some embodiments, the wireless device 110 may comprise a series of modules (or units) 128 configured to implement some or all of the functionalities of the wireless device 110 described above. More particularly, in some embodiments, the wireless device 110 may comprise a transmitting module configured to transmit, from a first RLC entity of the wireless device, first RLC PDUs, carrying data received from a PDCP entity of the wireless device, to a first RLC entity associated with a first set of cells over a primary logical channel, and from a second RLC entity of the wireless device second RLC PDUs, carrying duplicated data received from the PDCP entity of the wireless device, to a second RLC entity associated with a second set of cells over the secondary logical channel. The wireless device 110 may also comprise a determining module configured to determine a failure of a radio link supporting the secondary logical channel, and a notifying module configured to notify the radio network node about the failure of the radio link supporting the secondary logical channel.

It will be appreciated that the various modules 128 may be implemented as combination of hardware and/or software, for instance, the processor 114, memory 116, and transceiver(s) 112 of wireless device 110 shown in FIG. 7. Some embodiments may also include additional modules 128 to support additional and/or optional functionalities.

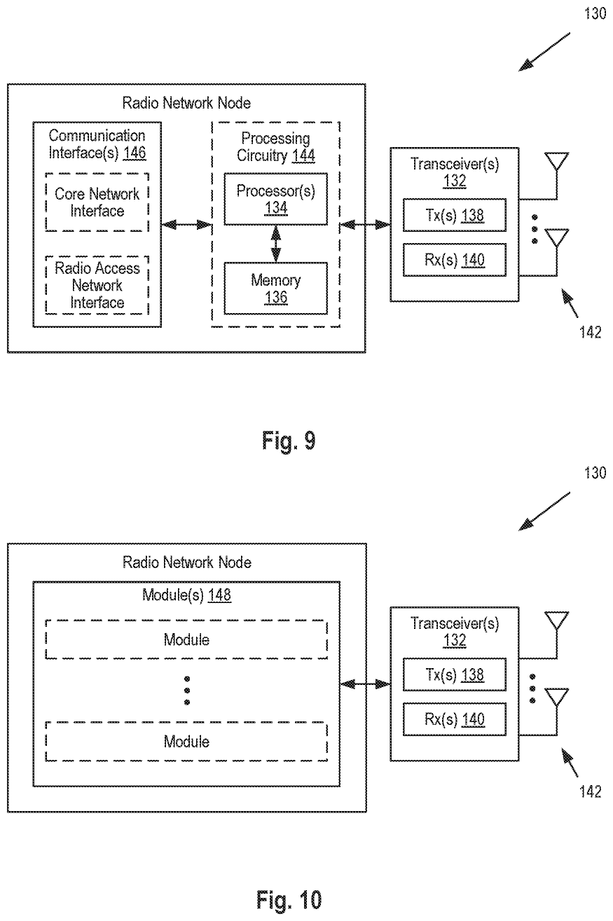

Embodiments of a radio network node 130 will now be described with respect to FIGS. 9 to 10. Even though the expression radio network node is used throughout the description, it is to be understood that the expression is used generically. In that sense, a radio network node generally refers to an equipment, or a combination of equipments, capable, configured, arranged and/or operable to communicate directly or indirectly with one or more wireless devices and/or with other network nodes or equipment in the wireless network to enable and/or provide wireless access to the wireless device(s) and/or to perform other functions (e.g., administration) in the wireless network.

Notably, different communication standards may use different terminology when referring to or describing radio network node. For instance, 3GPP uses the terms Node B (NB), evolved Node B (eNB), next-generation Node B (gNB), Radio Network Controller (RNC), and Base Station (BS). For its part, 3GPP2 uses the terms Access Node (AN), Base Station (BS), and Base Station Controller (BSC). And IEEE 802.11 (also known as WiFi™) uses the access point (AP). Understandably, the generic expression radio network node encompasses these terms.

FIG. 9 is a block diagram of an exemplary radio network node 130 according to some embodiments. Radio network node 130 may include one or more of a transceiver 132, a processor 134, a memory 136, and one or more communication interface(s) 146. In some embodiments, the transceiver 132 facilitates transmitting wireless signals to and receiving wireless signals from wireless devices 110 (e.g., via transmitter(s) (Tx) 138, receiver(s) (Rx) 140, and antenna(s) 142).

The processor 134 executes instructions to provide some or all of the functionalities described above as being provided by a radio network node 130, and the memory 136 stores the instructions to be executed by the processor 134. In some embodiments, the processor 134 and the memory 136 form processing circuitry 144. The communication interface(s) 146 enable the radio network 130 to communicate with other network nodes, including other radio network nodes (via a radio access network interface) and core network nodes (via a core network interface).

The processor 134 may include any suitable combination of hardware to execute instructions and manipulate data to perform some or all of the described functions of radio network node 130, such as those described above. In some embodiments, the processor 134 may include, for example, one or more computers, one or more central processing units (CPUs), one or more microprocessors, one or more application specific integrated circuits (ASICs), one or more field programmable gate arrays (FPGAs) and/or other logic.

The memory 136 is generally operable to store instructions, such as a computer program, software, an application including one or more of logic, rules, algorithms, code, tables, etc. and/or other instructions capable of being executed by a processor. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, the communication interface 146 is communicatively coupled to the processor 134 and may refer to any suitable device operable to receive input for radio network node 130, send output from radio network node 130, perform suitable processing of the input or output or both, communicate to other devices, or any combination of the preceding. The communication interface 146 may include appropriate hardware (e.g., port, modem, network interface card, etc.) and software, including protocol conversion and data processing capabilities, to communicate through a network.

Other embodiments of radio network node 130 may include additional components beyond those shown in FIG. 9 that may be responsible for providing certain aspects of the radio network node's functionalities, including any of the functionalities described above and/or any additional functionalities (including any functionality necessary to support the solutions described above). The various different types of network nodes may include components having the same physical hardware but configured (e.g., via programming) to support different radio access technologies, or may represent partly or entirely different physical components.

In some embodiments, the radio network node 130 may comprise a series of modules (or units) 148 configured to implement some or all the functionalities of the radio network node 130 described above. Referring to FIG. 10, in some embodiments, the radio network node 130 may comprise a (first) receiving module configured to received, at a PDCP entity of the radio network node, first RLC PDUs carrying data and second RLC PDUs carrying duplicated data, the first RLC PDUs being received from a first RLC entity of a wireless device over a primary logical channel via a first RLC entity associated with a first set of cells, and the second RLC PDUs being received from a second RLC entity of the wireless device over a secondary logical channel via a second RLC entity associated with a second set of cells. The radio network node 130 may also comprise a (second) receiving module configured to receive a notification from the wireless device about a failure of a radio link supporting the secondary logical channel.

It will be appreciated that the various modules 148 may be implemented as combination of hardware and/or software, for instance, the processor 134, memory 136, and transceiver(s) 132 of radio network node 130 shown in FIG. 9. Some embodiments may also include additional modules 148 to support additional and/or optional functionalities.

Some embodiments may be represented as a non-transitory software product stored in a machine-readable medium (also referred to as a computer-readable medium, a processor-readable medium, or a computer usable medium having a computer-readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description.

### ABBREVIATIONS AND ACRONYMS

The present description may comprise the following abbreviations and/or acronyms:

DC Dual Connectivity

eNB evolved Node B

EUTRAN Evolved Terrestrial Radio Access Network

MAC Medium Access Control

MCG Master Cell Group

PDCP Packed Data Convergence Protocol

PDU Protocol Data Unit

RLC Radio Link Control

RLF Radio Link Failure

RRC Radio Resource Control

SCG Secondary Cell Group

UE User Equipment

UMTS Universal Mobile Telecommunications System

### RELATED STANDARD REFERENCES

The following references may be related to the present description:

3GPP TS 36.323 V14.5.0—Packet Data Convergence Protocol (PDCP) Specification

3GPP TS 36.331 V15.0.1—Radio Resource Control (RRC) Protocol Specification

What is claimed is:

1. A method in a wireless device served by at least a first set of cells and a second set of cells, the wireless device being connected to at least one radio network node, the wireless device operating in a duplication mode, the method comprising:
transmitting, from a first Radio Link Control, RLC, entity of the wireless device, first RLC protocol data units, PDUs, carrying data received from a Packet Data Convergence Protocol, PDCP, entity of the wireless device, to a first RLC entity associated with the first set of cells over a primary logical channel, and from a second RLC entity of the wireless device, second RLC PDUs, carrying duplicated data received from the PDCP entity of the wireless device, to a second RLC entity associated with the second set of cells over a secondary logical channel;
determining failure of a radio link supporting the secondary logical channel;
responsive to determining failure of a radio link supporting the secondary logical channel, notifying the radio network node about the failure of a radio link supporting the secondary logical channel.

2. The method of claim 1, wherein notifying the radio network node about the failure of a radio link supporting the secondary logical channel comprises transmitting a message to the radio network node, the message comprising information about the failure of a radio link supporting the secondary logical channel.

3. The method of claim 2, wherein the message is a Radio Resource Control, RRC, message.

4. The method of claim 3, wherein the message is a PDCP-DuplicationFailureInformation message.

5. The method of any one of claims 2 to 4, wherein the information about the failure of a radio link supporting the secondary logical channel comprises an identity of the secondary logical channel, an identity of at least one cell of the second set of cells, an identity of a bearer carrying the secondary logical channel, and/or an identity of frequency resources associated with the radio link supporting the secondary logical channel.

6. The method of any one of claims 1 to 5, further comprising, responsive to determining failure of a radio link supporting the secondary logical channel, suspending the second RLC entity of the wireless device while keeping the first RLC entity active.

7. The method of any one of claims 1 to 6, further comprising receiving configuration information from the radio network node, the configuration information indicating that the primary logical channel is to be mapped to the first set of cells and that the secondary logical channel is to be mapped to the second set of cells.

8. The method of claim 7, further comprising, responsive to receiving configuration information from the radio network node, configuring the primary and secondary logical channels and the mapping of the primary logical channel to the first set of cells and the mapping of the secondary logical to the second set of cells.

9. The method of claim 7 or 8, wherein receiving configuration information from the radio network node comprises receiving a configuration message from the radio network node, the configuration message indicating that the primary logical channel is to be mapped to the first set of cells and that the secondary logical channel is to be mapped to the second set of cells.

10. The method of claim 9, wherein the configuration message is a Radio Resource Control, RRC, message.

11. The method of claim 10, wherein the message is an RRCConnectionSetup message or an RRCConnectionReconfiguration message.

12. The method of any one of claims 1 to 11, wherein the first set of cells and the second set of cells are both managed by the radio network node.

13. The method of any one of claims 1 to 11, wherein the first set of cells is managed by the radio network node and the second set of cells is managed by another radio network node.

14. The method of any one of claims 1 to 13, wherein the first set of cells comprises one or more cells, and wherein the second set of cells comprises one or more cells.

15. A wireless device, the wireless device being configured to be served by at least a first set of cells and a second set of cells, and to be connected to at least one radio network node, the wireless device being adapted to, when operating in a duplication mode:
transmit, from a first Radio Link Control, RLC, entity of the wireless device, first RLC protocol data units, PDUs, carrying data received from a Packet Data Convergence Protocol, PDCP, entity of the wireless device, to a first RLC entity associated with the first set of cells over a primary logical channel, and from a second RLC entity of the wireless device, second RLC PDUs, carrying duplicated data received from the PDCP entity of the wireless device, to a second RLC entity associated with the second set of cells over a secondary logical channel;
determine failure of a radio link supporting the secondary logical channel;
responsive to determining failure of a radio link supporting the secondary logical channel, notify the radio network node about the failure of a radio link supporting the secondary logical channel.

16. The wireless device of claim 15, further adapted to, when notifying the radio network node about the failure of a radio link supporting the secondary logical channel, transmit a message to the radio network node, the message comprising information about the failure of a radio link supporting the secondary logical channel.

17. The wireless device of claim 16, wherein the message is a Radio Resource Control, RRC, message.

18. The wireless device of claim 17, wherein the message is a PDCP-DuplicationFailureInformation message.

19. The wireless device of any one of claims 16 to 18, wherein the information about the failure of a radio link supporting the secondary logical channel comprises an identity of the secondary logical channel, an identity of at least one cell of the second set of cells, an identity of a bearer carrying the secondary logical channel, and/or an identity of frequency resources associated with the radio link supporting the secondary logical channel.

20. The wireless device of any one of claims 15 to 19, further adapted to, responsive to determining failure of a radio link supporting the secondary logical channel, suspend the second RLC entity of the wireless device while keeping the first RLC entity active.

21. The wireless device of any one of claims 15 to 20, further adapted to receive configuration information from the radio network node, the configuration information indicating that the primary logical channel is to be mapped to the first set of cells and that the secondary logical channel is to be mapped to the second set of cells.

22. The wireless device of claim 21, further adapted to, responsive to receiving configuration information from the radio network node, configure the primary and secondary logical channels and the mapping of the primary logical channel to the first set of cells and the mapping of the secondary logical to the second set of cells.

23. The wireless device of claim 21 or 22, further adapted to, when receiving configuration information from the radio network node, receive a configuration message from the radio network node, the configuration message indicating that the primary logical channel is to be mapped to the first set of cells and that the secondary logical channel is to be mapped to the second set of cells.

24. The wireless device of claim 23, wherein the configuration message is a Radio Resource Control, RRC, message.

25. The wireless device of claim 24, wherein the message is an RRCConnectionSetup message or an RRCConnectionReconfiguration message.

26. The wireless device of any one of claims 15 to 25, wherein the first set of cells and the second set of cells are both managed by the radio network node.

27. The wireless device of any one of claims 15 to 25, wherein the first set of cells is managed by the radio network node and the second set of cells is managed by another radio network node.

28. The wireless device of any one of claims 15 to 27, wherein the first set of cells comprises one or more cells, and wherein the second set of cells comprises one or more cells.

29. A computer program product comprising a non-transitory computer readable storage medium having computer readable program code embodied in the medium, the computer readable program code comprising computer readable program code to operate according to the method of any one of claims 1 to 14.

30. A method in a radio network node connected to a wireless device, the wireless device being served by at least a first set of cells and a second set of cells, the radio network node operating in a duplication mode, the method comprising:
receiving, at a Packet Data Convergence Protocol, PDCP, entity of the radio network node, first Radio Link Control, RLC, protocol data units, PDUs, carrying data received at a first RLC entity associated with the first set of cells from a first RLC entity of the wireless device over a first logical channel, and second RLC PDUs carrying duplicated data received at a second RLC entity associated with the second set of cells from a second RLC entity of the wireless device over a second logical channel;
receiving a notification from the wireless device about a failure of a radio link supporting the secondary logical channel.

31. The method of claim 30, further comprising, responsive to receiving a notification from the wireless device about a failure of a radio link supporting the secondary logical channel, suspending the second RLC entity associated with the second set of cells while keeping the first RLC entity associated with the first set of cells active.

32. The method of claim 30 or 31, further comprising transmitting configuration information to the wireless device, the configuration information indicating that the primary logical channel is to be mapped to the first set of cells and that the secondary logical channel is to be mapped to the second set of cells.

33. The method of claim 32, wherein transmitting configuration information to the wireless device comprises transmitting a configuration message to the wireless device, the configuration message indicating that the primary logical channel is to be mapped to the first set of cells and that the secondary logical channel is to be mapped to the second set of cells.

34. The method of claim 33, wherein the configuration message is a Radio Resource Control, RRC, message.

35. The method of claim 34, wherein the configuration message is an RRCConnectionSetup message or an RRCConnectionReconfiguration message.

36. The method of any one of claims 30 to 35, wherein receiving a notification from the wireless device about a failure of a radio link supporting the secondary logical channel comprises receiving a message from the wireless device, the message comprising information about the failure of a radio link supporting the secondary logical channel.

37. The method of claim 36, wherein the message is a Radio Resource Control, RRC, message.

38. The method of claim 37, wherein the message is a PDCP-DuplicationFailureInformation message.

39. The method of any one of claims 36 to 38, wherein the information about the failure of a radio link supporting the secondary logical channel comprises an identity of the secondary logical channel, an identity of at least one cell of the second set of cells, an identity of a bearer carrying the secondary logical channel, and/or an identity of frequency resources associated with the radio link supporting the secondary logical channel.

40. The method of any one of claims 30 to 39, wherein the first set of cells and the second set of cells are both managed by the radio network node.

41. The method of any one of claims 30 to 39, wherein the first set of cells is managed by the radio network node and the second set of cells is managed by another radio network node.

42. The method of any one of claims 30 to 41, wherein the first set of cells comprises one or more cells, and wherein the second set of cells comprises one or more cells.

43. A radio network node configured to be connected to a wireless device, the wireless device being configured to be served by at least a first set of cells and a second set of cells, the radio network node being adapted to, when operating in a duplication mode:
receive, at a Packet Data Convergence Protocol, PDCP, entity of the radio network node, first Radio Link Control, RLC, protocol data units, PDUs, carrying data received at a first RLC entity associated with the first set of cells from a first RLC entity of the wireless device over a first logical channel, and second RLC PDUs carrying duplicated data received at a second RLC entity associated with the second set of cells from a second RLC entity of the wireless device over a second logical channel;
receive a notification from the wireless device about a failure of a radio link supporting the secondary logical channel.

44. The radio network node of claim 43, further adapted to, responsive to receiving a notification from the wireless device about a failure of a radio link supporting the secondary logical channel, suspend the second RLC entity associated with the second set of cells while keeping the first RLC entity associated with the first set of cells active.

45. The radio network node of claim 43 or 44, further adapted to transmit configuration information to the wireless device, the configuration information indicating that the primary logical channel is to be mapped to the first set of cells and that the secondary logical channel is to be mapped to the second set of cells.

46. The radio network node of claim 45, further adapted to, when transmitting configuration information to the wireless device, transmit a configuration message to the wireless device, the configuration message indicating that the primary logical channel is to be mapped to the first set of cells and that the secondary logical channel is to be mapped to the second set of cells.

47. The radio network node of claim 46, wherein the configuration message is a Radio Resource Control, RRC, message.

48. The radio network node of claim 47, wherein the configuration message is an RRCConnectionSetup message or an RRCConnectionReconfiguration message.

49. The radio network node of any one of claims 43 to 48, further adapted to, when receiving a notification from the wireless device about a failure of a radio link supporting the secondary logical channel, receive a message from the wireless device, the message comprising information about the failure of a radio link supporting the secondary logical channel.

50. The radio network node of claim 49, wherein the message is a Radio Resource Control, RRC, message.

51. The radio network node of claim 50, wherein the message is a PDCP-DuplicationFailureInformation message.

52. The radio network node of any one of claims 49 to 51, wherein the information about the failure of a radio link supporting the secondary logical channel comprises an identity of the secondary logical channel, an identity of at least one cell of the second set of cells, an identity of a bearer carrying the secondary logical channel, and/or an identity of frequency resources associated with the radio link supporting the secondary logical channel.

53. The radio network node of any one of claims 43 to 52, wherein the first set of cells and the second set of cells are both managed by the radio network node.

54. The radio network node of any one of claims 43 to 52, wherein the first set of cells is managed by the radio network node and the second set of cells is managed by another radio network node.

55. The radio network node of any one of claims 43 to 54, wherein the first set of cells comprises one or more cells, and wherein the second set of cells comprises one or more cells.

56. A computer program product comprising a non-transitory computer readable storage medium having computer readable program code embodied in the medium, the computer readable program code comprising computer readable program code to operate according to the method of any one of claims 30 to 42.
